(19) United States
(12) Patent Application Publication
(10) Pub. No.: US 2015/0151986 A1
(43) Pub. Date: Jun. 4, 2015

(54) Method and Apparatus for Conditioning Fresh and Saline Water

(71) Applicants: Roger E. Fearon, Houston, TX (US); Jeffrey M. Carlitz, Houston, TX (US); Seenappa Poola, Sugar Land, TX (US); Michael A. Champ, Falls Church, VA (US); James Smallwood, Santa Barbara, CA (US); Jessica Bobenrieth, San Antonio, TX (US)

(72) Inventors: Roger E. Fearon, Houston, TX (US); Jeffrey M. Carlitz, Houston, TX (US); Seenappa Poola, Sugar Land, TX (US); Michael A. Champ, Falls Church, VA (US); James Smallwood, Santa Barbara, CA (US); Jessica Bobenrieth, San Antonio, TX (US)

(73) Assignee: TRANSGLOBAL H2O, LLC., Houston, TX (US)

(21) Appl. No.: 14/600,900

(22) Filed: Jan. 20, 2015

Related U.S. Application Data
(63) Continuation-in-part of application No. 13/845,240, filed on Mar. 18, 2013.

(51) Int. Cl. C02F 1/461; C02F 1/469; E21B 43/34; B09C 1/00; B09C 1/08; C02F 1/46; B09C 1/02

(52) U.S. Cl. CPC C02F 1/46104; C02F 1/4604; C02F 1/4602; C02F 1/4693; B09C 1/02; B09C 1/002; B09C 1/085; E21B 43/34; C02F 2201/4611

(57) ABSTRACT

A method and apparatus for conditioning and treating water is disclosed. Water including impurities flows past a charge probe. The charge probe is energized to ionize the water. The ionized water passes a grounding probe which removes free electrons from the ionized water to produce positively-charged water and impurities suspended in the positively-charged water downstream of the grounding probe. The positively-charged water is filtered or treating the water at a treatment unit. In one embodiment, the water may be included with fluid produced from a wellbore during a fracking operation, in which embodiment hydrocarbons obtained during the fracking operation and suspended in the positively-charged water downstream of the grounding probe are filtered to remove the hydrocarbons from the ionized water.

### CROSS-REFERENCE TO RELATED APPLICATIONS

This application is a continuation-in-part of application Ser. No. 13/845,240, filed Mar. 18, 2013, the contents of which are incorporated herein in their entirety.

### BACKGROUND OF THE DISCLOSURE

1. Field of the Disclosure

The present application is related to water conditioning and treatment and, in particular, to a method and apparatus for altering an electronegative state of impurities in the water to dissociate the impurities from the water.

2. Description of the Related Art

Agricultural yield from a field is related to the irrigation water quality and quantity used to water a crop in the field. A field that is irrigated with high quality fresh water containing a low level of chemical impurities will produce a large agricultural crops product per unit area compared to a field that is irrigated with brackish or saline water, or saline ground water. Water that is provided directly from a “freshwater” source (such as a water source having less than 500 pm Total Dissolved Solids (TDS)) to the field may still include a number of impurities, such as salt cations, carbonaceous material, bacteria, etc., that may affect crop yield. Thus, it is desirable to make these impurities in the water less available to the plants during the irrigation process. Also, in various locations, soils may be unable to grow plants either because the only nearby reservoirs or local ground water provide saline water or otherwise brackish reservoirs or because the soils are inherently abundant in saline and other impurities that are hazardous to crop production. Thus, it is also desirable to flush impurities from the soil to make the soil usable for agricultural purposes.

### SUMMARY OF THE DISCLOSURE

In one aspect the present disclosure provides a method of conditioning water, including: flowing the water including impurities past a charge probe; energizing the charge probe to ionize the water; passing the ionized water past a grounding probe to remove free electrons from the ionized water to produce positively-charged water and impurities suspended in the positively-charged water downstream of the grounding probe; and treating the water at a treatment unit.

In another embodiment, the present disclosure provides an apparatus for conditioning water, the apparatus including: a flow passage configured to flow the water; a charge probe disposed in the flow passage; a control unit configured to energize the charge probe to ionize the water in the flow passage; a grounding member downstream of the charge probe configured to remove free electrons from the ionized water; and a treatment unit for treating the water.

In yet another aspect, the present disclosure provides a method of providing water for a land application, including: flowing fluid produced from a wellbore during a fracking operation through a flow passage, the fluid including water and hydrocarbons; energizing a charge probe at a location along the flow passage to ionize the fluid in the flow passage; passing the ionized water past a grounding probe to remove free electrons from the ionized water to produce positively-charged water and hydrocarbons suspended in the positively-charged water downstream of the grounding probe; passing the positively-charged water through a filter to remove the hydrocarbons from the ionized water; and treating the filtered water. The filter may be a soil media filter for removing excess salt cations.

In yet another aspect, the present disclosure provides an apparatus for providing water for land application, the apparatus including: a member providing a flow passage through which fluid produced from a wellbore during a fracking operation is flowed, wherein the fluid includes water and hydrocarbons; a charge probe at a selected location along the member, the charge probe configured to ionize the fluid in the flow passage; a grounding probe downstream of the charge probe configured to remove free electrons from the ionized fluid to produce positively-charged water with hydrocarbons suspended therein downstream of the grounding probe; a filter downstream of the grounding probe for filtering the hydrocarbons from the fracking operation; and a treatment unit in the member for treating the fluid. The filter may be a soil media filter for removing excess salt cations.

Examples of certain features of the apparatus and method disclosed herein are summarized rather broadly in order that the detailed description thereof that follows may be better understood. There are, of course, additional features of the apparatus and method disclosed hereinafter that will form the subject of the claims.

### BRIEF DESCRIPTION OF THE DRAWINGS

The present disclosure is best understood with reference to the accompanying figures in which like numerals refer to like elements and in which:

FIG. 1 shows a water conditioning and treatment system in an exemplary embodiment of the present invention;

FIG. 2 shows an exemplary circuit that may be provided at control unit for energizing a probe of the water treatment system of FIG. 1;

FIG. 3 shows exemplary square waves generated by the circuit of FIG. 2;

FIG. 4 shows an alternative flow passage suitable for water treatment using the exemplary methods disclosed herein;

FIG. 5 shows a water treatment apparatus of the present invention in an alternative embodiment;

FIG. 6 shows an exemplary electrostatic spray unit suitable for treating and dispensing water using the exemplary methods disclosed herein; and

FIG. 7 illustrates and effect of irrigation of a soil using water conditioned using the methods disclosed herein;

FIG. 8 shows an exemplary system using the water conditioning device for descaling a well and/or attached or associated downstream irrigation pipes;

FIG. 9 shows an exemplary power system suitable for use with the exemplary water conditioning apparatus disclosed herein;

FIG. 10 shows an exemplary ship or boat that may be suitable for use with the exemplary water condition apparatus disclosed herein;

FIG. 11 shows an exemplary use of the treatment system 1100 of the present invention in an embodiment for treating water produced from a fracking operation; and

FIG. 12 illustrates a post-treatment and pre-treatment apparatus for water conditioning and treatment.

### DETAILED DESCRIPTION OF THE DISCLOSURE

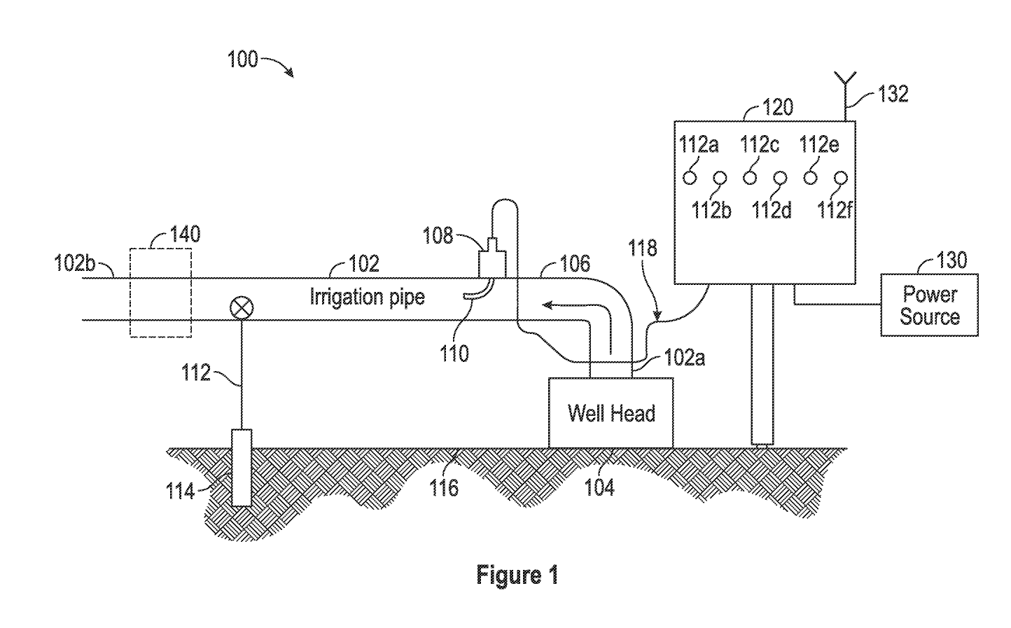

FIG. 1 shows a water conditioning and treatment system 100 in an exemplary embodiment of the present invention. The exemplary water conditioning system 100 includes a flow passage 102 having water or a fluid 106 flowing therein from an upstream end 102a to a downstream end 102b. In various embodiments, the flow passage 102 may include an enclosed flow passage such as pipe, a conduit, an irrigation pipe, a hose, etc. The upstream end 102a of the flow passage 102 may be coupled to a well head 104 which, in an exemplary embodiment, delivers water to the flow passage 102 from a reservoir beneath the ground. However, the upstream end 102a of the flow passage 102 may be coupled to an alternate water source, such as a water tank, in alternate embodiments of the invention. In an exemplary embodiment, the water 106 exits the flow passage 102 at the downstream end 102b to be delivered to a field for irrigation purposes or to some other suitable destination. In various embodiments, the present invention may be used with various irrigation methods including, but not limited to, spray irrigation, tape irrigation, drip irrigation, flood irrigation, subsurface irrigation, overhead sprinklers, ground sprayers, Center Pivot irrigation, etc. Also, the water may be used in ground sprinklers on golf courses, parade grounds, football fields, residential lawns, and/or a plant cultivation system, etc. In various embodiments, the water 106 at the upstream end 102a may include various impurities which may include, but is not limited to, algae, bacteria, E. coli, foliar nematode, phylloxera, phytopthera, Pierce's Disease, Iron Bacteria, nematodes, mealy bugs, ants, spider mites, aphids, and mildew.

One or more probes 110 or electrodes may be coupled to the flow passage 102. In an exemplary embodiment, the one or more probes 110 may be disposed within the flow passage 102 so that the water 106 flows around the one or more probes 110 and makes direct contact with the one or more probes 110. In various embodiments, the one or more probes 110 are inserted into a hole formed in the flow passage 110 and secured into position within the water flow via a suitable fitting 108. In one embodiment, the one or more probes 110 may include a conductive rod or probe that extends into the water 106 flowing in the flow passage 102. The dimension of the one or more probes 110 may be selected to be suitable to the dimensions of the flow passage 102. One end of a charge wire 118 may be coupled to the one or more probes 110 at the fitting 108. Another end of the charge wire 118 may be coupled to a control unit 120 in order to complete an electrical circuit between the control unit 120 and the one or more probes 110. The control unit 120 may transmit an electrical waveform along the charge wire 118 to the one or more probes 110 in the flow passage 102 to cause the one or more probes 110 to transmit electromagnetic energy into the water 106. In various embodiments, the one or more probes 110 transmit energy in order to excite and/or ionize water molecules and/or impurities in the water 106. In an exemplary embodiment, electromagnetic energy may be transmitted into the water within a frequency range from about 10 Hertz to about 10,000 Hertz. In another embodiment, the electromagnetic energy may be transmitted at a frequency selected for rendering inactive or destroying any bacteria or other living organisms in the water 106. In alternate embodiments, the frequency may be selected to remove scaling and/or impurities such as saline or carbonaceous compounds from the water. The one or more probes 110 are shown disposed within the flow passage 102 so as to come into direct contact with the water flowing therein. Power source 130 may supply power to the control panel 120. In an exemplary embodiment, the power source 130 may be a power outlet. Alternately, the power source 130 may include a solar unit, a wind-powered generator, or other suitable generator.

The flow passage 102 may be made of an electrically conductive material, such as steel. In various embodiments, the electrically conductive flow passage 102 may be electrically grounded. In an exemplary embodiment, a grounding wire 112 made of copper or other suitable conductive wire is electrically coupled to a ground probe that is inserted into the electrically conductive flow passage 102 and/or electrically coupled at another end to a grounding rod 114 made of copper or other suitable conductive member to ground the flow passage 102. In an exemplary embodiment, the grounding rod 114 is implanted 6 feet into the earth 116 in order to provide an electrical ground for the removing free electrons from ionized water in the flow passage 102. Other methods and devices for grounding the water in the flow passage 102 may be used in alternate embodiments.

In various embodiments, the control unit 120 energizes the one or more probes 110 disposed in the flowing water 106 to ionize the water and/or impurities in the water. In one embodiment, the energy from the one or more probes 110 may create ionized (positively charged) water molecules, ionized (positively charged) impurity molecules (for example, ionized salt, “salt cations”) and one or more free electrons. Since the flow passage 102 is electrically grounded, the free electrons are electrically attracted to the walls of the flow passage 102, through the grounding wire 112 and grounding rod 114 into the earth 116. With the free electrons removed, the fluid in the flow passage 102 includes positively-charged water ions and/or positively-charged impurities suspended in the water. The positively-charged impurities and the positively-charged water repel each other.

Due to the distribution of electrical charge amongst its constituent atoms, water molecules have a dipole moment. Electrical attraction between water molecules due to this dipole moment pulls individual water molecules closer together, making it more difficult to separate the water molecules and therefore raising the boiling point, surface tension, adhesion, cohesion, and soil moisture evaporation rates, and the soil stays wetter longer. When an ionic polar compound enters the water, it is surrounded by water molecules in a process known as hydration. If the compound has properties that allow it to resist these attractive intermolecular forces, then the compound may be “pushed out” from the water molecules and does not dissolve in the water. Using the methods disclosed herein, the ions and the impurities may be ionized to have the same charge. Therefore, they are mutually electrically repellant and resistant to combining with each other. Thus, at the downhole end 102b of the flow passage 102, the impurities are suspended in the positive-charged water and dissociated from the water. When the conditioned water is deposited on the ground, the impurities are separated from the positively-charged water by sinking deep into the ground and away from the roots of the agricultural crop and the salt cations become neutralized. These impurities thus become biologically unavailable to the plants. Meanwhile, the positively-charged water clings to soil and roots for use in hydrating the crop.

Prior to depositing the excited water in the field, the excited water may be treated using a treatment system 140 downstream of the one or more probes 110. In various embodiments, the additional treatment system may include other technologies that can be applied to the water either before or after using the water-excitation methods disclosed herein or both before and after the water-excitation method. In one embodiment, multiple treatment systems may be interleaved between multiple water-excitation systems in an alternating fashion. Such treatments include, but is not limited to, the following technologies: electrocoagulation, water filtration, a cross-flow membrane system, a desalination reverse osmosis treatment unit, a brackish water reverse osmosis treatment unit, a forward osmosis treatment unit, and/or a range of physical-chemical wastewater precipitation, chemical oxidation, carbon adsorption, ultrafiltration (UF) reverse osmosis (RO) electro-dialysis, volatilization and gas stripping. Other additional water conditioning systems not specifically disclosed herein may also be used with the present invention.

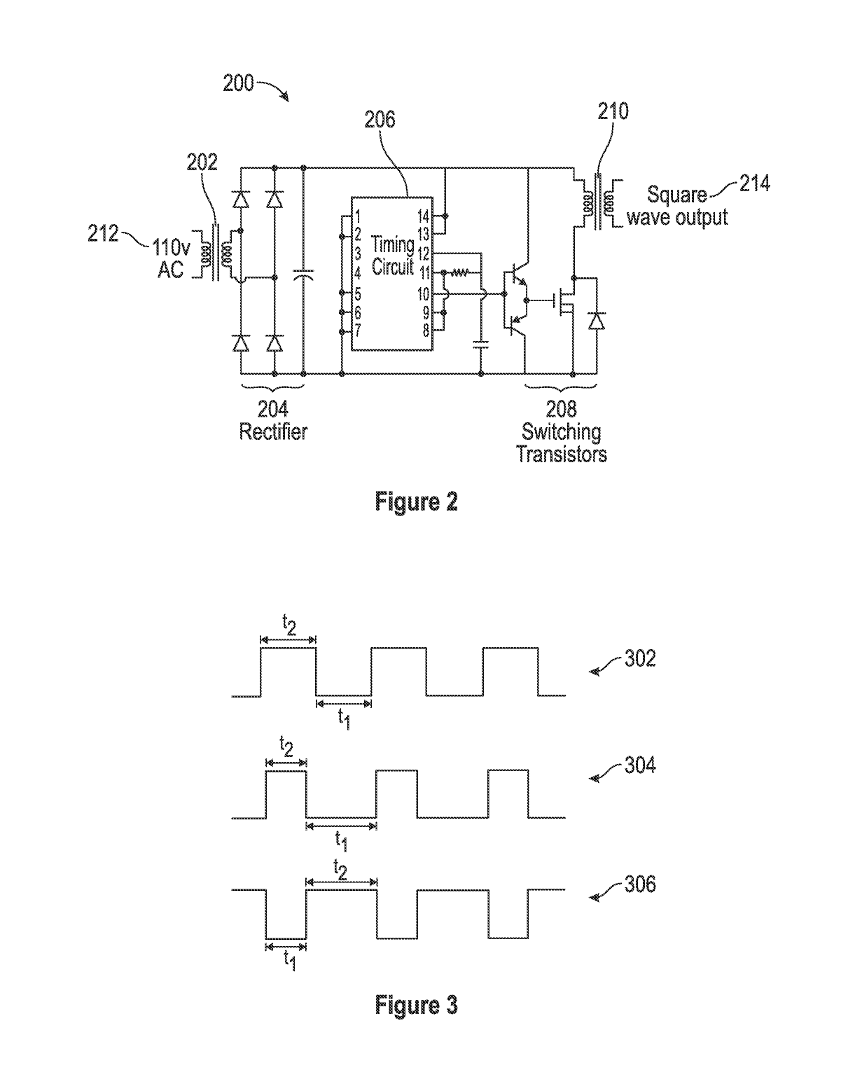

FIG. 2 shows an exemplary circuit 200 that may be provided at the control unit 120 for energizing the one or more probes 110 of the water conditioning system 100 of FIG. 1. The exemplary circuit 200 includes step-down transformer 202 for receive an input voltage 212, which is 110V AC input in the exemplary embodiment, but which may be any suitable voltage. The step-down transformer 202 reduces the voltage to suitable voltage amplitude, such as 12 V AC. The step-down transformer 202 is coupled to a rectifier circuit 204 that converts the alternating current voltage (i.e., 12 V AC) to a direct current voltage (i.e., 12 V DC). In alternate embodiments, a DC voltage may be supplied to the circuit 200. The DC voltage is provided to a timing circuit 206 that operates switching transistors 208 for generating a selected output waveform 214 at a step-up transformer 212. The step-up transformer 210 increases the amplitude of the output waveform and supplies the amplified output waveform to the one or more probes (110, FIG. 1) to excite the molecules of the water (106, FIG. 1) in the flow passage (102, FIG. 1). In various embodiments, the timing circuit 206 may control a frequency and amplitude as well as a shape of the output waveform 214 generated by the switching transistors 208. The timing circuit 206 may be a pre-programmed circuit or alternately a circuit that may be configured by a user so as to alter a parameter of the output waveform 214 to a value selected by a user. In an exemplary embodiment, the output waveform 214 is a square wave. In alternate embodiments, the output waveform 214 may be a sine wave, a saw tooth wave, a rectangular wave, a sinusoidal waveform or other suitable waveform for which the waveform is above a selected excitation level of the water for a selected amount of time. In one embodiment, the waveform may be above the selected excitation level for more than about 40%-50% of the period of the waveform. The selected excitation level may be an ionization level of the water molecules or of any suitable compound.

FIG. 3 shows exemplary square waves generated by the circuit 200 of FIG. 2. The square wave may be at substantially 0 volts for a time duration t₁ and at the maximum voltage (Vₘₐₓ) for a selected time duration t₂. In one embodiment, the timing circuit 206 may control the duration of the times t₁ and t₂. In square wave 302, t₁=t₂. In square 304, t₁>t₂. In square wave 306, t₁<t₂. In general, a square wave is selected in order to provide an extended amount of time (i.e., time t₂) over which an ionization potential may be applied to the water 106. In various embodiments, t₂ is greater than about 40% of the entire period of the waveform. This is in contrast to a waveform that produces an electrical spike that may provide very short ionization potential over a relatively short period of time. The circuit 200 is capable of producing waveforms having a frequency over any selected frequency range. In several embodiments, the waveform generator produces waveforms having frequencies between about 1 kilohertz (kHz) and about 10 kHz. Additionally, a waveform may have a specific frequency selected to provide biological to stress to a wide range of biological organisms or to dissociate a selected impurity from the water 106.

Referring back to FIG. 1, the control unit 120 may include a plurality of circuits 200 that are configured to energize the one or more probes 110. In the exemplary embodiment, the control unit 120 includes six such circuits 200 that may be coupled together and/or synchronized. Each circuit 200 may be configured to provide a waveform suitable for performing a separate water conditioning process. For example, a first circuit may be configured to produce a waveform within a frequency range suitable for water ionization, while a second circuit may be configured to produce a waveform within a frequency range for killing a selected bacterium, etc. The waveforms may be applied to the one or more probes 110 in any selected combination, such as sequentially, substantially simultaneously, or in a selected combination for waveform superposition. Lights 112a-f at the control unit 120 may be used to monitor the circuits 200 wherein each light 112a-f is associated with a selected circuit 200. When a circuit 200 fails or becomes faulty, the associated light may change from a lit state to an unlit state, or vice-versa. A user may either replace the faulty circuit 200 at the control unit 120 or replace the entire control unit 120 upon observing from the lights 112a-f that one or more circuits 200 are faulty. Additionally, the control unit 102 may include a transducer 132 for communication between the control unit 102 and a remote device (not shown). The remote device may then be used to monitor the control unit 120 and its transformers and to turn the control unit 120 on and off. Additionally, the remote device may initiate transmission of data recorded at the control unit 120, that data related to date, time, flow, and other agriculture and environmental parameters related to assessment of crop production.

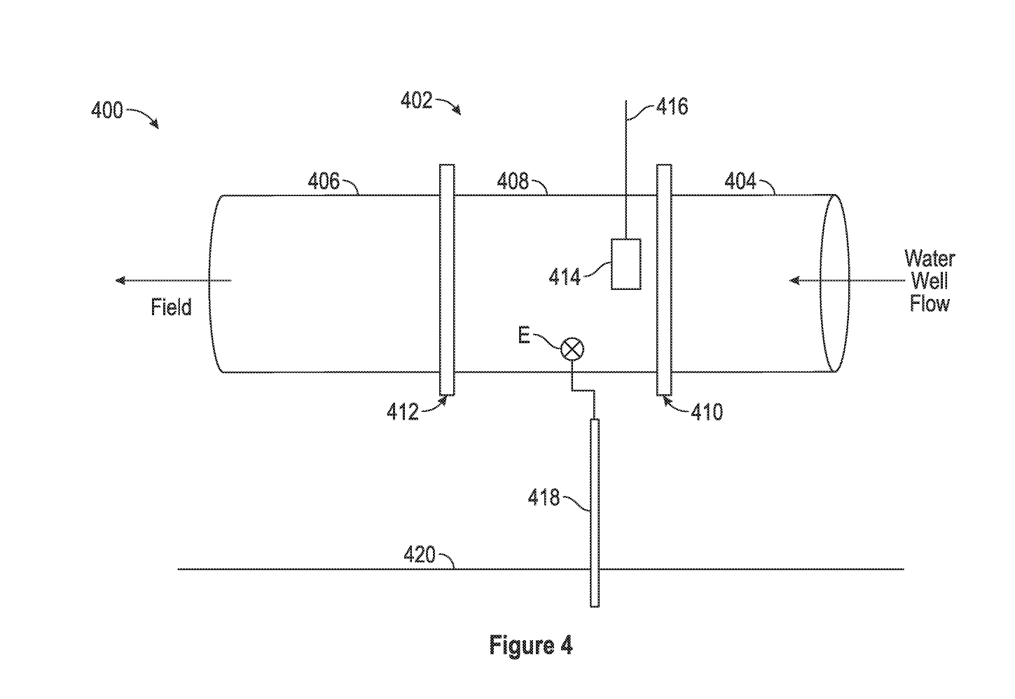

FIG. 4 shows an alternative flow passage 400 suitable for water conditioning using the exemplary methods disclosed herein. In FIG. 4, water flow is from right to left from a well or other suitable water source to a field or other suitable water destination. The flow passage includes an upstream conduit 404 and a downstream conduit 406. The upstream conduit 404 and the downstream conduit 406 may be made of a non-metallic material, such as poly-vinyl chloride (PVC) material. A water conditioning assembly 402 is disposed between the upstream conduit 404 and the downstream conduit 406 for the purposes of performing the water conditioning methods disclosed herein. The water conditioning assembly 402 includes an electrically conductive conduit 408 that is coupled to the upstream conduit 404 via flange 410 and to downstream conduit 406 via flange 412. The water conditioning assembly 402 further comprises a probe 414 disposed in an interior of the conductive conduit 408 and a charge wire 416 coupled to the probe 414. Once the electrically conductive conduit 408 is coupled to the electrically non-conductive conduits 404 and 406, the charge wire 416 may be coupled to the exemplary control panel (120, FIG. 1) in order to provide a channel for energizing the probe 414. Additionally, the exemplary water conditioning assembly 402 includes a grounding member 416 for grounding the electrically conductive conduit 408 to the earth 420. The exemplary flow passage 400 may be assembled as described below.

A single PVC pipe may be cut so as to remove a section of the PVC pipe, thereby leaving the upstream conduit 404 and the downstream conduit 406 with a gap there between. The length of the gap is selected to be substantially the same as a length of the electrically conductive conduit 408. The conductive conduit 408 of the water conditioning assembly 402 may then be installed between the upstream conduit 404 and the downstream conduit 406 using respective flanges 410 and 412. Once the conductive conduit 408 is installed, the grounding member 418 may be inserted into the earth 420 and the charge wire 416 may be coupled to the control panel 120. The water condition assembly 402 may then be used to condition water using the methods disclosed herein.

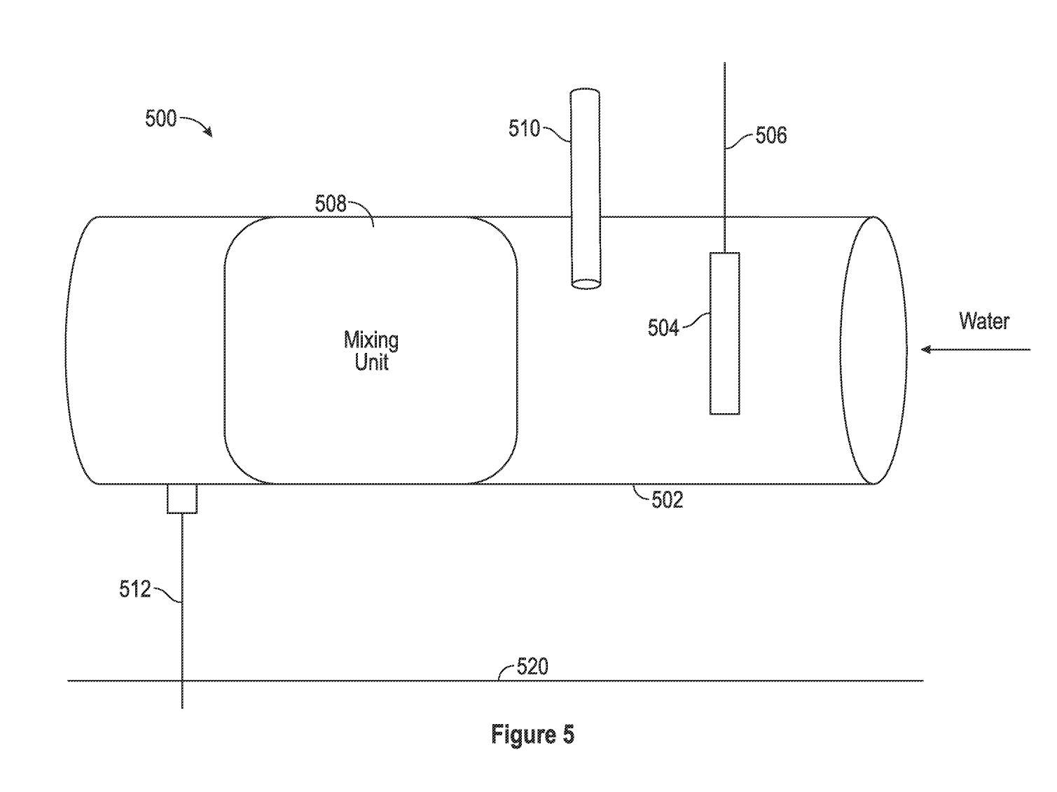

FIG. 5 shows a water condition apparatus 500 of the present invention in an alternative embodiment. An electrically conductive conduit 502 includes a probe 504 disposed therein and a grounding member 512 for removing free electrons. Water is shown as flowing from right to left through the conductive conduit 502. The probe 504 is coupled to a control unit (i.e., 110, FIG. 1) via charging wire 506. The probe 504 excites the molecules of water and/or impurities in the water within the conductive conduit 502 when energized by the control unit 110. An in-line mixing unit 508 is disposed in the conductive conduit 502 downstream of the probe 504. An oxygen source 510 is provided upstream of the mixing unit 508. The in-line mixing unit 508 produces turbulence in the water, thereby mixing oxygen from the oxygen source 510 with the water. Oxygen is separated into small bubbles at the mixing unit 508. The small oxygen bubbles increases a surface area between the oxygen and the water, which increases a surface area for distributing the charge throughout the water, thereby increasing the number of ionized water molecules downstream of the mixing unit 508. Grounding member 512 removes free electrons from the water downstream of the charge probe 504, mixing unit 508 and grounding member 512.

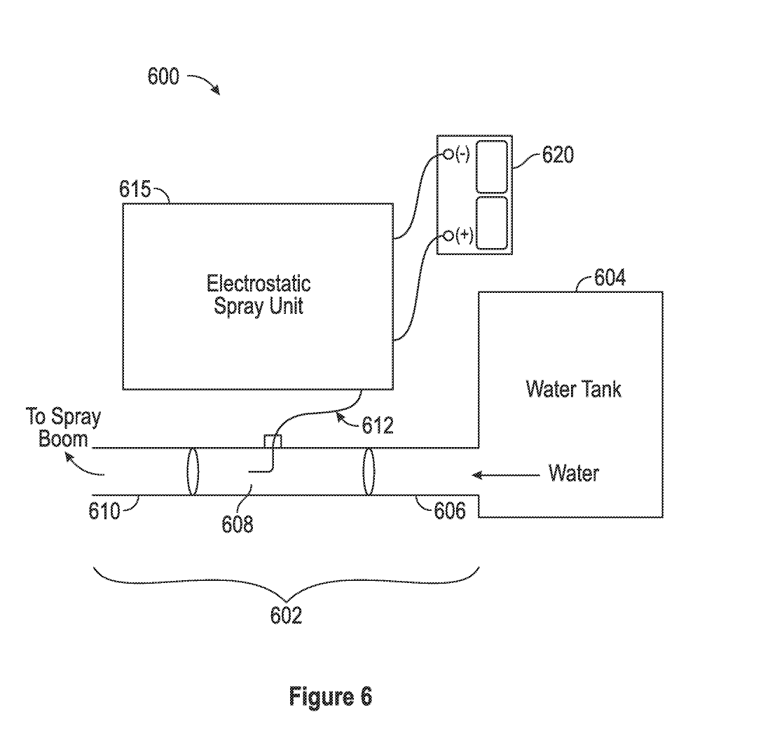

FIG. 6 shows an exemplary electrostatic spray unit 600 suitable for conditioning and dispensing water using the exemplary methods disclosed herein. The electrostatic spray unit 600 includes a hose 602 receiving a water flow from a water tank 604 at an input end of the hose 602 and dispensing the water to a spray boom or other dispensing device at an output end of the hose 602. In various embodiments, the water tank 604 may be conveyed by a mobile unit, such as a tractor, wagon, trailer, etc., so that the water tank 604 may be moved between one or more water dispensing locations. The hose 602 may be segmented into an upstream hose portion 606 and a downstream hose portion 610 that are electrically non-conductive and an electrically conductive hose portion 608 that is coupled to the upstream hose portion 606 and downstream hose portion 610 to provide the continuous hose 602 for water flow. The upstream hose portion 606 and downstream hose portion 610 may be made of rubber or other flexible material. The conductive hose portion 608 may include a stainless steel pipe or other suitable electrically conductive material. Charge wire 612 may be inserted inside the hose portion 608 and secured to the conductive hose portion 608 using a suitable device, such as a clamp, etc. The charge wire 612 may then be coupled to an electrostatic spray unit 615 for providing one or more waveforms to the wall of the conductive hose portion 608 to excite and/or ionize the water and or impurities in the water flowing therein. The spray unit 615 may be powered by a battery 620 such as a tractor battery.

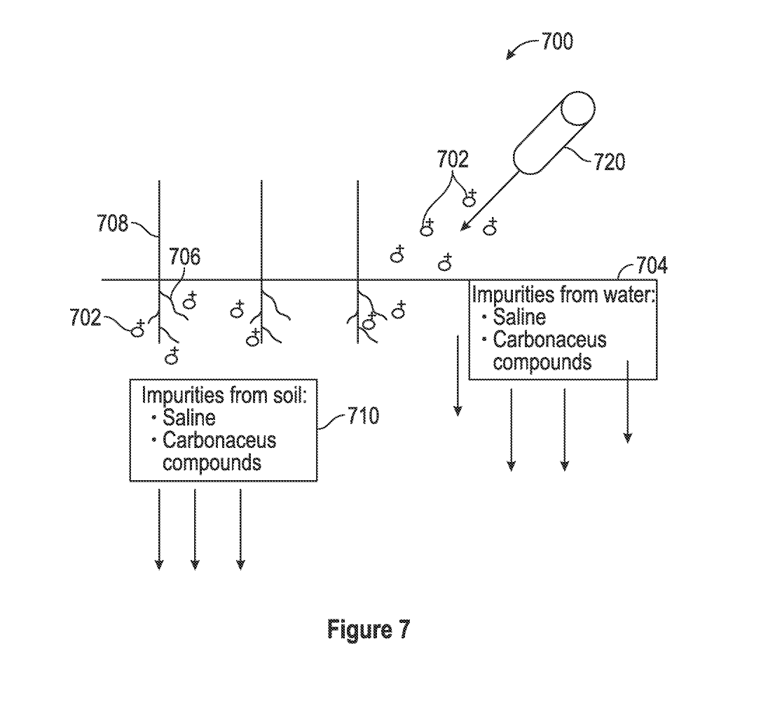

FIG. 7 illustrates effects of an exemplary irrigation process 700 that results from using the water conditioned using the methods disclosed herein. The positively-charged water 702 and the positively-charged impurities 704 are deposited on the soil from an irrigation pipe 720. The positively-charged water has extensive hydrogen bonding, greater surface tension and more adhesion and cohesion to the roots 706 of the plants 708. The impurities 704 from the water drain through the soil to a depth that is out of the reach of the roots. Similarly, conditioned water 702 that does not adhere to the roots may drain impurities 710 pre-existing in the previously-unusable soil to a lower depth out of reach of roots 706, leaving behind soil that may be used or reclaimed for agricultural purposes. Additionally, the conditioned water may affect growth of microorganisms and fungi in the soil, which may include compost, mulch, wood chips, etc.

The water conditioning system may induce a charge into the water which causes the sprayed water to be attracted to the soil and the plant. This attraction prevents drift and increases coverage of the sprayed liquid fertilizer onto plant surface including under the plant leaf. Additionally, exciting the water may further causes a release of hydrogen, oxygen and ozone into the water, producing a hydrogen, oxygen and ozone rich environment in which virus and bacteria cannot live.

Table 1 below shows results of paired field trails for irrigating crops using the water conditioned using the exemplary methods disclosed herein. Each crop is planted in a first field irrigated with unconditioned water (“control water”) and a second field irrigated with water conditioned using the methods disclosed herein. Often, the first field and the second field are adjoining. The first column of Table 1 displays a selected crop. The second column discloses the field and water conditions, wherein the first field receives the water as stated directly in column 2 and the second field receives the water in column 2 after it has been conditioned using the methods disclosed herein. The third column displays results comparing crops from the second field and the first field.

TABLE 1

| | | Increase in |
|---|---|---|
| Crop | Field and Water Conditions | Crop Production/Acre |
| Barley | Saline Soils w/ Well Water | More than 70% |
| | 1,500 mg/l TDS | |
| Organic | Low Saline Soils w/Well | Whale Variety = 14.8% |
| Spinach | Water 600 mg/l TDS | Solomon Variety = 17.5% |
| Organic | Green House w/Well Water, | 2.8% more lbs of tomatoes |
| Tomatoes | RO down to 200 mg/l | for Trial that was watered |
| | TDS | with conditioned irrigation |
| | | water |

For barley crop, the first field was and the second field was saline soils. The first field was irrigated with well water having 1,500 milligrams per liter (mg/l) of Total Dissolved Solids (TDS). The second field was irrigated with the same well water except that the well water was conditioned using the methods disclosed herein prior to being deposited on the second field. The second field produced 70% more barley per acre than the first field.

For organic spinach crop, the first field and the second field were low saline soils. A whale variety of spinach and a Solomon variety of spinach was planted in each field. The first field was irrigated with well water having 600 mg/l TDS. The second field was irrigated with the same well water except that the well water was conditioned using the methods disclosed herein prior to being deposited on the second field. For the whale variety of spinach, the second field produced 14.8% more spinach per acre than the first field. For the Solomon variety of spinach, the second field produced 17.5% more spinach per acre than the first field.

For tomato crop, a greenhouse soil was used for the first and second fields. The first field was irrigated with reversed osmosis water having 200 mg/l TDS. The second field was irrigated with the same water except that the water was conditioned using the methods disclosed herein prior to being deposited on the second field. The second field produced 2.8% more pounds of tomatoes than the second field. For organic strawberries, the second field produced 7.5% more flats of strawberries per acre over the growing season.

Additional results were also found. For example, seeds that are watered using the conditioned water (“conditioned seeds”) germinate earlier than seeds that are watered using unconditioned water (“control seeds). In some examples, conditioned seeds germinate about 5 to about 7 days earlier than control seeds. More conditioned seeds reached the germination stage than did control seeds. In an exemplary experiment, the number of conditioned seeds that reached germination was 5 times (per unit area) the number of control seeds that reached germination. Conditioned seeds experience faster root growth than control seeds. The root growth in the conditioned seeds preceded root growth in control seeds by about 5 to about 7 days. In addition, conditioned seeds watered experience faster plant growth and leafing out than seeds watered using unconditioned water. Thus, more plants survive seed germination using conditioned water and the plants are faster growing plants that produce more leaves than plants watered using unconditioned water.

Conditioned seeds further grew taller plants by about twice the height of control seeds and had bigger leaves, healthier and greener plants than control seeds. The conditioned seeds had faster seed pod germination and earlier seed development in seed pods, by about 10 days over control seeds. More than 1.5 conditioned seeds were produced per seed pod vs. every 1 seed per pod from the control seeds. Additionally, irrigating the plants with conditioned water reduced plant death from osmotic stress over plants irrigated with non-conditioned water. Rain falling on lands irrigated with conditioned water would serve to nourish the plants. On the other hand, rain falling on lands subjected to the control water irrigation dissolved into soil various surface salts deposited therein from the unconditioned water, thereby increasing the number of plant deaths with the control water. Irrigating with conditioned water further reduced plant death by desiccation due to exposure to heat from high air temperatures (e.g., over 100° F.) and in periods of high-dry winds. Lastly, irrigating with conditioned water was seen to increase development of nitrogen fixing bacterial and nitrogen levels in soils.

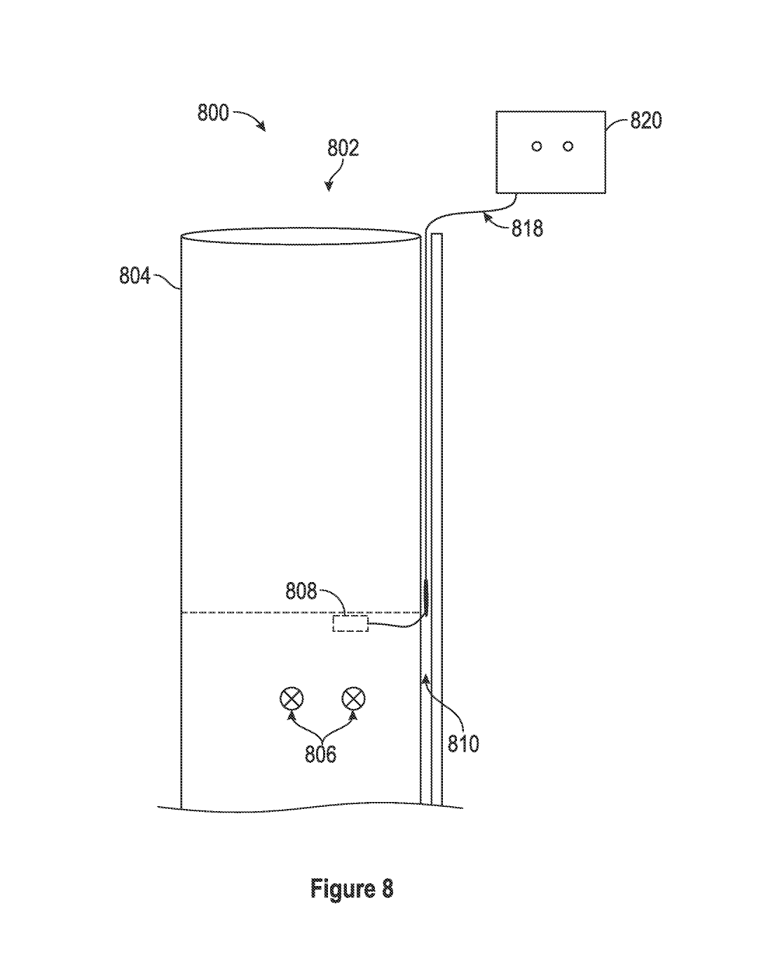

FIG. 8 shows an exemplary system 800 using the water conditioning device for descaling a well 802 and/or attached or associated downstream irrigation pipes. The formation of scale occurs when hard minerals are deposited on metal surfaces inside pumps, valves and irrigation pipes and spray nozzles due to changes in pressure and temperature, etc. The present invention may reduce and/or prevent scale formation in irrigation equipment as well as dissociate scale from same irrigation equipment. In the exemplary system, pipe 804 is disposed in the well 802 for delivering water or a fluid from beneath the earth to a surface of the earth. Pumps 806 may be locating at a depth within the pipe 804 for pumping the water to the surface. A charge wire 818 may be extended down the well along an exterior of the pipe 804, for example, down a sounding tube 810 proximate the pipe 804. A probe 808 may be positioned and centered inside the pipe 804. The probe 808 may be inside the pipe 804 at a depth that is above the depth of the pumps 806. In the illustrative embodiment shown in FIG. 8, pumps 806 are at a depth of 350 feet and probe 808 is at a depth of 320 feet. The probe 808 is coupled to control unit 820 via the charge wire 818. In an exemplary embodiment, the control unit 820 energizes the probe 808 at a frequency that reduces a scaling in the pipe and at the pumps.

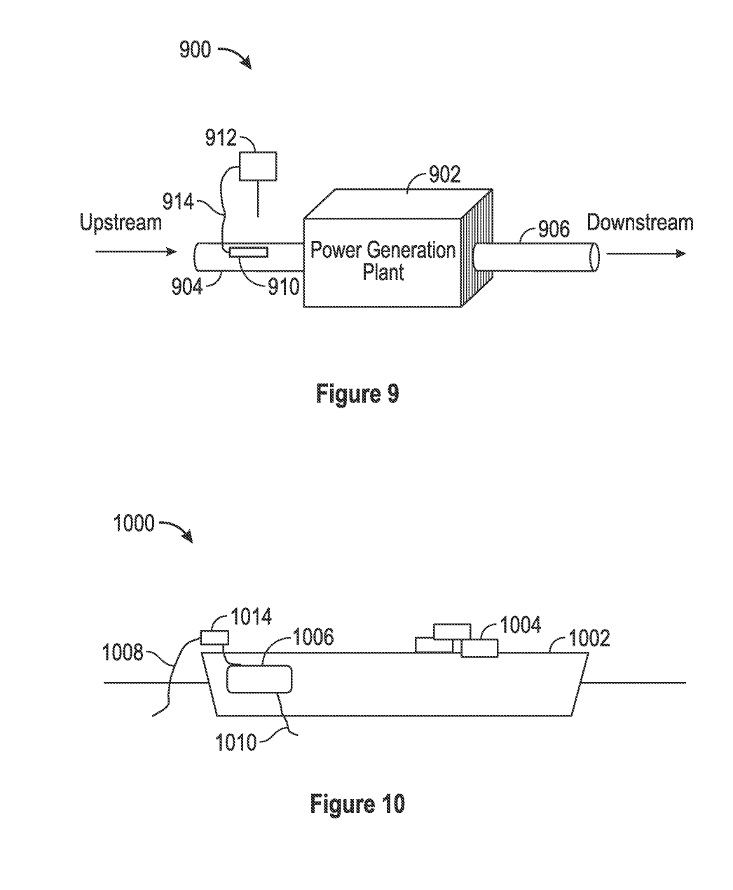

FIG. 9 shows an exemplary power system 900 suitable for use with the exemplary water conditioning apparatus disclosed herein. The exemplary power system 900 includes a power generation plant 902 that receives water from a water source via intake 904, such as at a location upstream of the power generation plant 902. In various embodiments, the power generation plant 902 may include a nuclear power plant, a coal-powered electrical plant, a petroleum-powered electrical plant, etc. The received water may be used in various aspects of power generation, such as in cooling water systems and heat exchangers. Used water is then emptied back to the water source via outlet 906, such as at a location downstream of the power generation plant 902. In one embodiment, one or more probes 910 may be disposed within intake 904 and coupled to control unit 912 via a charge wire 914 or other suitable coupling device. The control unit 912 may energize the one or more probes 910 at a frequency selected to reduce scaling and/or to descale previously-scaled pipes of the power generation plant 902, such as pipes used in cooling water systems and heat exchangers. By descaling theses pipes and/or preventing scaling in the pipes, the exemplary power system 900 may run more efficiently, reducing energy costs and reducing the frequency and duration of maintenance operations.

FIG. 10 shows an exemplary ship 1000 that may be suitable for use with the exemplary water condition apparatus disclosed herein for treatment of invasive species in ballast water. Exemplary ships 1000 may include a naval vessel, a cargo ship, a cruise ship, submarine, or other aquatic vessel, where trans-ocean routes or multiple coastal ports are visited and wherein a mass 1004 is carried therein that may significantly affect a balance of the ship. The ship 1000 includes a hull 1002 that carries a mass 1004 that may be cargo, passengers, etc. In an exemplary embodiment, the mass 1004 is placed on a selected section of the hull 1002 when the ship is at a first port. Water is drawn from the first port via intake 1008 to be contained in tank 1006 in order to provide ballast that counterbalances the mass 1004. Although only one tank 1006 is shown, a ship 1000 may include multiple tanks 1006 in order to balance the ship for various distributions of the mass 1004. In general, the ship 1000 may convey the mass 1004 to a second port as well as the counterbalancing water in tank 1006. At the second port, the mass is unloaded from the ship 1000 and the water is also released from the tank 1006 into the second port via output device 1010. Often, organisms may be drawn up into the tank 1006 from the first port that may be hazardous to the ecosystem of the second port. The organisms may be invasive species in the form of either eggs or larvae or in their juvenile or adult stages. In an exemplary embodiment, the exemplary water conditioner 1014 disclosed herein may be coupled to the intake 1006 and/or to the tank 1006. The water in the intake 1006 may be charged using the methods disclosed herein. The charged water is grounded in order to remove free electrons to leave behind positive-charged water molecules that include the organism. The positively-charged water and organism are then passed through a filter, which may be a soil media filter, to neutralize any salt cations in the water and filter the salt cations from the water. The filtered water is then used as ballast water and has a reduced concentration of salt cations therein. The filtered ballast water has an increased osmotic stress in comparison to the water immediately retrieved from the first port at the first intake. Such ballast water is not supportive to the salt water organisms now in the ballast water. Thus, the organisms die and are not introduced into the second port as viable organisms. The water conditioner 1014 may also be energized at a frequency to reduce the survivability of the invasive species in the water drawn from the first port. Therefore, water may be safely emptied into the second port without introducing living organisms from the first port into the second port, thereby preserving the ecosystem of the second port. Exemplary organisms that may be destroyed via the exemplary water conditioner 1014 may include, but is not limited to, larval stages of invasive species such as Zebra Mussels, and Chinese Green Crab. Additionally, the ship may intake water for power generation purposes. The intake water may be treating using the exemplary conditioner 1014 in order to prevent scaling in the pipes used in heat transfer and cooling systems in generating power for the ship 1000.

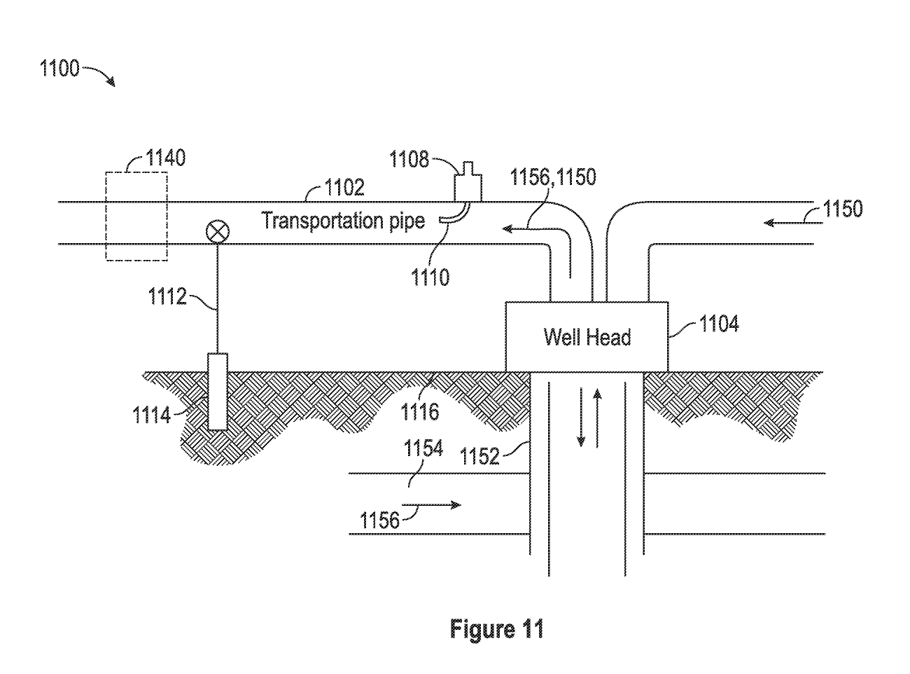

FIG. 11 shows an exemplary use of the treatment system 1100 of the present invention in an embodiment for treating water produced from a fracking operation. A fracking (or fracturing) operation includes the pumping of water and/or other fluids 1150 into a wellbore 1152 and into an underground reservoir 1154 in order to fracture the reservoir 1154, causing the release of hydrocarbons and other fluids 1156 (which are highly saline) from the reservoir 1154. The released fluids 1156 and the pumped fracking fluids 1150 are then brought to the surface where water carried therein may be separated from the recovered and separated from the hydrocarbons. In some embodiments, the fluid from the formation may also include water retrieved from the reservoir 1154. In various embodiments, the water produced in the fracking operation is passed through a water conditioning and treatment system such as shown in FIG. 11. The exemplary water conditioning and treatment system 1100 includes a flow passage 1102 for flowing the fluids 1156, 1150 that are a by-product of the fracking operation. The flow passage 1102 includes an enclosed flow passage such as pipe, a conduit, an irrigation pipe, a hose, etc. The flow passage 1102 is coupled to a well head 1104 from which production fluids are produced from the fracking operation.

Charge probe 1110 is coupled to the flow passage 1102 so that the produced fluid 1156, 1150 flows around the charge probe 1110 and makes direct contact with the charge probe 1110. The charge probe 1110 may be inserted into a hole formed in the flow passage 1102 and secured into position within the water flow via a suitable fitting 1108. The charge probe 1110 includes a conductive rod/probe that extends into the produced fluid 1156, 1150 flowing in the flow passage 1102. The charge probe 1110 is activated by a control unit (not shown) in order to transmit an electrical waveform to the charge probe 1110 to cause the charge probe 1110 to transmit electromagnetic energy into the fluid 1156, 1150. The transmitted electromagnetic energy excites and/or ionizes the produced fluid 1156, 1150, including water molecules and/or hydrocarbons in the produce fluid 1156, 1150. The electromagnetic energy may be within a frequency range from about 10 Hertz to about 10,000 Hertz.

The electromagnetic energy from the charge probe 1110 creates ionized (positive) water molecules and free electrons. Ground probe 1112 removes the free electrons from the production fluid 1106 to provide (positive) ionized fluids, such as ionized water and ionized hydrocarbons and deposits the free electrons into earth 1116 via conductive rod 1114.

The excited water may be treated using a treatment system 1140. In one embodiment, multiple water-excitation systems and treatment systems may be alternately applied to the water or of fluid. In one embodiment, the treatment system includes an electrocoagulation treatment system. Additional treatments may include, but are not limited to: water filtration, a cross-flow membrane system, a desalination reverse osmosis treatment unit, a brackish water reverse osmosis treatment unit, a forward osmosis treatment unit, and/or a range of physical-chemical wastewater precipitation, chemical oxidation, carbon adsorption, ultrafiltration (UF) reverse osmosis (RO) electro-dialysis, volatilization and gas stripping, etc.

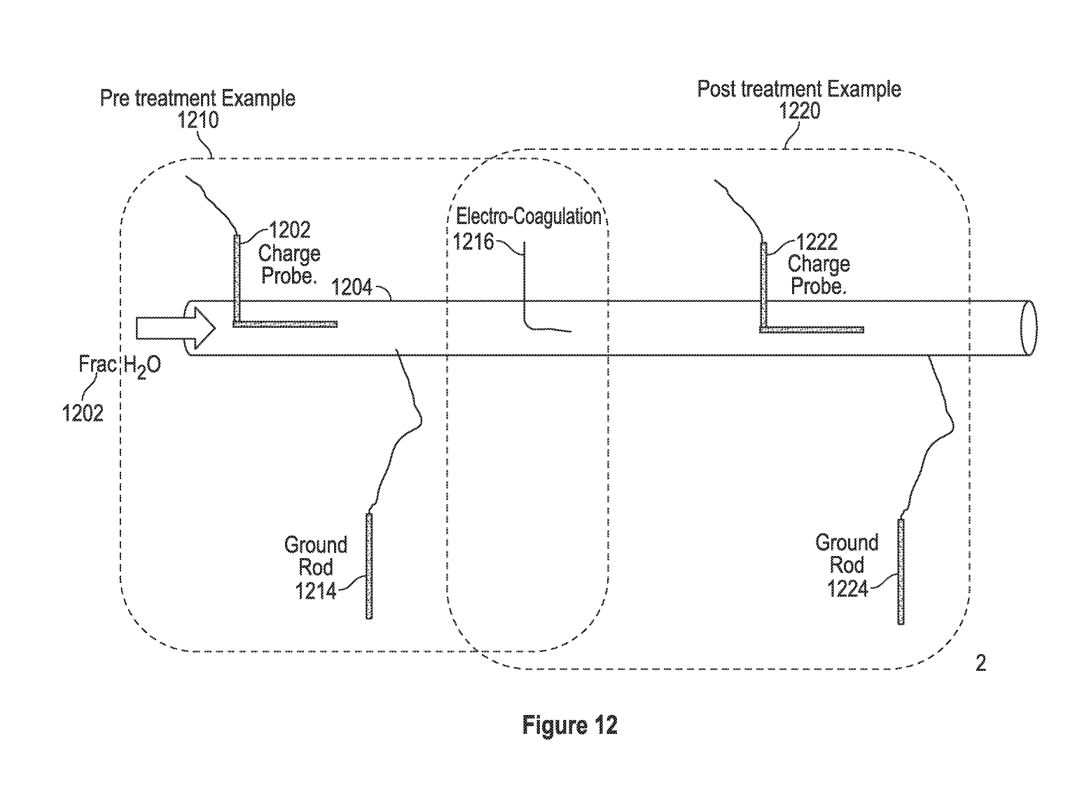

FIG. 12 illustrates a post-treatment and pre-treatment apparatus for water conditioning and treatment. A fracking fluid and water 1202 are shown traversing a flow passage 1204 from left to right, as shown in the FIG. 12. An example 1210 of pre-treating the fluid shows a charge probe 1212, a grounding rod 1214 downstream of the charge probe 1212, and an electro-coagulation unit 1216 downstream of the grounding rod 1214. In the pre-treatment example 1210, the fluid is conditioned first using the methods disclosed herein and then treated via electrocoagulation. An example 1220 of post-treating the fluid includes a charge probe 1222 downstream of the electrocoagulation unit 1216 and a grounding rod 1224 downstream of the charge probe 1222. In the post-treatment example 1210, the fluid is first treated via electrocoagulation and then conditioned using the methods disclosed herein. In some embodiments, pre-treatment and post-treatment of the water may be performed so that an electrocoagulation unit is upstream of the charge probe and another electrocoagulation unit is downstream of the grounding rod. In one embodiment, multiple water-excitation systems and treatment systems may be alternately applied to the water or of fluid.

Therefore, in one aspect the present disclosure provides a method of conditioning water, including: flowing the water including impurities past a charge probe; energizing the charge probe to ionize the water; passing the ionized water past a grounding probe to remove free electrons from the ionized water to produce positively-charged water and impurities suspended in the positively-charged water downstream of the grounding probe; and treating the water at a treatment unit. The probe may be energized using a periodic waveform having a frequency that is selected from at least one of: within a frequency range from about 10 Hertz to about 10,000 Hertz; and within a selected frequency range for affecting an ionic nature of an impurity in the water; and within a selected frequency range for providing a stress to a biological organism in the water. The waveform may be: a square waveform; a rectangular waveform; a sinusoidal waveform; and a periodic waveform that provides a voltage suitable for ionizing the water for at least 40% of the period of the waveform, in various embodiments. A concentration of positive ions in the water downstream of the grounding probe may be increased by passing the ionized water through using a mixer unit prior to passing the ionized water past the grounding probe. The probe may be energized using a solar power supply. The treatment unit may be located either upstream of the charge probe and/or downstream of the grounding probe. The treatment unit may be any one of: an electrocoagulation unit, a water filtration unit, a cross-flow membrane system; a desalination reverse osmosis treatment unit; a brackish water reverse osmosis treatment unit; a forward osmosis treatment unit; a physical-chemical wastewater precipitation unit; a chemical oxidation unit; a carbon adsorption unit; an ultrafiltration unit; a reverse osmosis unit; an electro-dialysis unit; a volatilization unit; and a gas stripping unit.

In another aspect, the present disclosure provides an apparatus for conditioning water, the apparatus including: a flow passage configured to flow the water; a charge probe disposed in the flow passage; a control unit configured to energize the charge probe to ionize the water in the flow passage; a grounding member downstream of the charge probe configured to remove free electrons from the ionized water; and a treatment unit for treating the water. The control unit may energize the probe using a waveform that has a frequency that is at least one of: within a frequency range from about 10 Hertz to about 10,000 Hertz; within a selected frequency range for affecting an ionic nature of an impurity in the water; and within a selected frequency range for providing a stress to a biological organism in the water. The control unit may further energize the probe using a waveform that is at least one of: a square waveform; a rectangular waveform; a sinusoidal waveform; and a periodic waveform that provides a voltage suitable for ionizing the water for at least 40% of the period of the waveform. The treatment unit may be any of: an electrocoagulation unit, a water filtration unit, a cross-flow membrane system; a desalination reverse osmosis treatment unit; a brackish water reverse osmosis treatment unit; a forward osmosis treatment unit; a physical-chemical wastewater precipitation unit; a chemical oxidation unit; a carbon adsorption unit; an ultrafiltration unit; a reverse osmosis unit; an electro-dialysis unit; a volatilization unit; and a gas stripping unit. The treatment unit can be located either upstream of the charge probe, downstream of the grounding member or with a first treatment unit upstream of the charge probe and a second treatment unit downstream of the grounding member.

In yet another aspect, the present disclosure provides a method of providing water for a land application, including: flowing fluid produced from a wellbore during a fracking operation through a flow passage, the fluid including water and hydrocarbons; energizing a charge probe at a location along the flow passage to ionize the fluid in the flow passage; passing the ionized water past a grounding probe to remove free electrons from the ionized water to produce positively-charged water and hydrocarbons suspended in the positively-charged water downstream of the grounding probe; passing the positively-charged water through a soil media filter to remove the hydrocarbons from the ionized water; and treating the filtered water. The filtered water may be treated by performing at least one of: an electrocoagulation treatment, a water filtration, flowing the water in a cross-flow membrane system; a desalination reverse osmosis treatment; a brackish water reverse osmosis treatment; and a forward osmosis treatment; a physical-chemical wastewater precipitation treatment, a chemical oxidation treatment, a carbon adsorption treatment, an ultrafiltration treatment, a reverse osmosis treatment, and electro-dialysis treatment, a volatilization treatment and a gas stripping treatment. The fluid produced from the fracking operation can includes at least one of: water pumped into a wellbore to perform the fracking operation; and water produced from a formation as a result of the fracking operation. The treating of the fluid may include performing electrocoagulation either upstream of the charge probe, downstream of the grounding probe or performing a first electrocoagulation upstream of the charge probe and a second electrocoagulation downstream of the grounding member.

In yet another aspect, the present disclosure provides an apparatus for providing water for land application, the apparatus including: a member providing a flow passage through which fluid produced from a wellbore during a fracking operation is flowed, wherein the fluid includes water and hydrocarbons; a charge probe at a selected location along the member, the charge probe configured to ionize the fluid in the flow passage; a grounding probe downstream of the charge probe configured to remove free electrons from the ionized fluid to produce positively-charged water with hydrocarbons suspended therein downstream of the grounding probe; a filter downstream of the grounding probe for filtering the hydrocarbons from the fracking operation; and a treatment unit in the member for treating the fluid. The treatment unit may include at least one of: an electrocoagulation treatment, a water filtration, flowing the water in a cross-flow membrane system; a desalination reverse osmosis treatment; a brackish water reverse osmosis treatment; and a forward osmosis treatment; a physical-chemical wastewater precipitation treatment, a chemical oxidation treatment, a carbon adsorption treatment, an ultrafiltration treatment, a reverse osmosis treatment, and electro-dialysis treatment, a volatilization treatment and a gas stripping treatment. The fluid produced from the fracking operation may include water pumped into a wellbore to perform the fracking operation and/or water produced from a formation as a result of the fracking operation. The treatment unit may be located either upstream of the charge probe, downstream of the filter and/or a first treatment unit located upstream of the charge probe and a second treatment unit located downstream of the filter.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of conditioning water, comprising:
flowing the water including impurities past a charge probe;
energizing the charge probe to ionize the water;
passing the ionized water past a grounding probe to remove free electrons from the ionized water to produce positively-charged water and impurities suspended in the positively-charged water downstream of the grounding probe; and
treating the water at a treatment unit.

2. The method of claim 1, further comprising energizing the probe using a periodic waveform having a frequency that is selected from at least one of: within a frequency range from about 10 Hertz to about 10,000 Hertz; and within a selected frequency range for affecting an ionic nature of an impurity in the water; and within a selected frequency range for providing a stress to a biological organism in the water.

3. The method of claim 2 wherein the waveform is at least one of: a square waveform; a rectangular waveform; a sinusoidal waveform; and a periodic waveform that provides a voltage suitable for ionizing the water for at least 40% of the period of the waveform.

4. The method of claim 1, further comprising increasing a concentration of positive ions in the water downstream of the grounding probe by passing the ionized water through using a mixer unit prior to passing the ionized water past the grounding probe.

5. The method of claim 1, further comprising energizing the probe using a solar power supply.

6. The method of claim 1, wherein the treatment unit is located at one of: (i) upstream of the charge probe; and (ii) downstream of the grounding probe.

7. The method of claim 1, wherein the treatment unit is at least one of: an electrocoagulation unit, a water filtration unit, a cross-flow membrane system; a desalination reverse osmosis treatment unit; a brackish water reverse osmosis treatment unit; a forward osmosis treatment unit; a physical-chemical wastewater precipitation unit; a chemical oxidation unit; a carbon adsorption unit; an ultrafiltration unit; a reverse osmosis unit; an electro-dialysis unit; a volatilization unit; and a gas stripping unit.

8. An apparatus for conditioning water, comprising:
a flow passage configured to flow the water;
a charge probe disposed in the flow passage;
a control unit configured to energize the charge probe to ionize the water in the flow passage;
a grounding member downstream of the charge probe configured to remove free electrons from the ionized water; and
a treatment unit for treating the water.

9. The apparatus of claim 8, wherein the control unit is further configured to energize the probe using a waveform that has a frequency that is at least one of: within a frequency range from about 10 Hertz to about 10,000 Hertz; within a selected frequency range for affecting an ionic nature of an impurity in the water; and within a selected frequency range for providing a stress to a biological organism in the water.

10. The apparatus of claim 9, wherein the control unit is further configured to energize the probe using a waveform that is at least one of: a square waveform; a rectangular waveform; a sinusoidal waveform; and a periodic waveform that provides a voltage suitable for ionizing the water for at least 40% of the period of the waveform.

11. The apparatus of claim 8, wherein the water treatment unit is at least one of: an electrocoagulation unit, a water filtration unit, a cross-flow membrane system; a desalination reverse osmosis treatment unit; a brackish water reverse osmosis treatment unit; a forward osmosis treatment unit; a physical-chemical wastewater precipitation unit; a chemical oxidation unit; a carbon adsorption unit; an ultrafiltration unit; a reverse osmosis unit; an electro-dialysis unit; a volatilization unit; and a gas stripping unit.

12. The apparatus of claim 8, wherein the treatment unit is located at one of: (i) upstream of the charge probe; and (ii) downstream of the grounding member.

13. A method of providing water for a land application, comprising:
flowing fluid produced from a wellbore during a fracking operation through a flow passage, the fluid including water and hydrocarbons;
energizing a charge probe at a location along the flow passage to ionize the fluid in the flow passage;
passing the ionized water past a grounding probe to remove free electrons from the ionized water to produce positively-charged water and hydrocarbons suspended in the positively-charged water downstream of the grounding probe;
passing the positively-charged water through a filter to remove the hydrocarbons from the ionized water; and
treating the filtered water.

14. The method of claim 13, wherein treating the filtered water further comprises performing at least one of: an electrocoagulation treatment, a water filtration, flowing the water in a cross-flow membrane system; a desalination reverse osmosis treatment; a brackish water reverse osmosis treatment; and a forward osmosis treatment; a physical-chemical wastewater precipitation treatment, a chemical oxidation treatment, a carbon adsorption treatment, an ultrafiltration treatment, a reverse osmosis treatment, and electro-dialysis treatment, a volatilization treatment and a gas stripping treatment.

15. The method of claim 13, wherein the fluid produced from the fracking operation includes at least one of: (i) water pumped into a wellbore to perform the fracking operation; (ii) water produced from a formation as a result of the fracking operation.

16. The method of claim 13, further comprising performing electrocoagulation at one of: (i) upstream of the charge probe; and (ii) downstream of the filter.

17. An apparatus for providing water for land application, comprising:
a member providing a flow passage through which fluid produced from a wellbore during a fracking operation is flowed, wherein the fluid includes water and hydrocarbons;
a charge probe at a selected location along the member, the charge probe configured to ionize the fluid in the flow passage;
a grounding probe downstream of the charge probe configured to remove free electrons from the ionized fluid to produce positively-charged water with hydrocarbons suspended therein downstream of the grounding probe;
a filter downstream of the grounding probe for filtering the hydrocarbons from the fracking operation; and
a treatment unit in the member for treating the fluid.

18. The method of claim 17, wherein the treatment unit includes at least one of: an electrocoagulation treatment, a water filtration, flowing the water in a cross-flow membrane system; a desalination reverse osmosis treatment; a brackish water reverse osmosis treatment; and a forward osmosis treatment; a physical-chemical wastewater precipitation treatment, a chemical oxidation treatment, a carbon adsorption treatment, an ultrafiltration treatment, a reverse osmosis treatment, and electro-dialysis treatment, a volatilization treatment and a gas stripping treatment.

19. The method of claim 17, wherein the fluid produced from the fracking operation includes at least one of: (i) water pumped into a wellbore to perform the fracking operation; (ii) water produced from a formation as a result of the fracking operation.

20. The method of claim 17, wherein the treatment unit is located at one of: (i) upstream of the charge probe; and (ii) downstream of the filter.
